(19) United States
(12) Patent Application Publication
(10) Pub. No.: US 2017/0327037 A1
(43) Pub. Date: Nov. 16, 2017

(54) ADAPTIVE REAR VIEW DISPLAY

(71) Applicant: Ford Global Technologies, LLC, Dearborn, MI (US)

(72) Inventors: Kwaku O. Prakah-Asante, Commerce Twp., MI (US); Satish B. Chikkannanavar, Canton, MI (US); Venkataramani Anandan, Farmington Hills, MI (US)

(21) Appl. No.: 15/151,241

(22) Filed: May 10, 2016

(51) Int. Cl. B60R 1/00; B60R 11/04; H04N 7/18

(52) U.S. Cl. CPC B60R 1/00; H04N 7/183; B60R 11/04; B60R 2300/207; B60R 2300/8066

(57) ABSTRACT

System and methods to provide an adaptive rear view display are disclosed. An example disclosed first vehicle includes a rear view camera and an adaptive display controller. The example adaptive display controller is to determine, with range detection sensors, a following-time of a second vehicle behind the first vehicle. The example adaptive display controller is also to determine a workload estimate associated with the first vehicle. Additionally, when the first vehicle is moving forward, the adaptive display controller is to selectively display video from the rear view camera based on the following-time, the workload estimate, and a user request.

### TECHNICAL FIELD

The present disclosure generally relates to vehicles with rear view cameras and, more specifically, an adaptive rear view display.

### BACKGROUND

Increasingly, vehicles are being manufactured with backup cameras that provide a view behind the vehicle. These cameras help drivers avoid obstacles when the vehicle is backing up or parking. These vehicles have displays on the center console or on a portion of a rear-view mirror. Generally, when the vehicle is moving forward, the backup camera is off and the center console displays an interface for an infotainment system.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments to provide an adaptive rear view display are disclosed. An example disclosed first vehicle includes a rear view camera and an adaptive display controller. The example adaptive display controller is to determine, with range detection sensors, a following-time of a second vehicle behind the first vehicle. The example adaptive display controller is also to determine a workload estimate associated with the user of the first vehicle. Additionally, when the first vehicle is moving forward, the adaptive display controller is to selectively display video from the rear view camera based on the following-time and the workload estimate.

An example method to provide a driver a view behind a first vehicle includes determining a following time of a second vehicle behind the first vehicle. The second vehicle is detected by range detection sensors. The example method also includes determining a workload estimate associated with the user of the first vehicle. Additionally, when the first vehicle is moving forward, selectively displaying video from a rear view camera based on the following-time and the workload estimate.

A tangible computer readable medium comprising instructions that, when executed, cause a first vehicle to determine a following-time of a second vehicle behind the first vehicle. The second vehicle is detected by range detection sensors. The instructions cause the first vehicle to determine a workload estimate associated with the user of the first vehicle. Additionally, the instructions cause the first vehicle to, when the first vehicle is moving forward, selectively display video from a rear view camera based on the following-time and the workload estimate.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 is a top view of a vehicle operating in accordance with the teachings of this disclosure.

FIG. 2 is a block diagram of electronic components of the vehicle of FIG. 1.

FIG. 3 is a block diagram of the adaptive display controller of FIGS. 1 and 2.

FIG. 4 is a flowchart of an example method to provide an adaptive rear view display that may be implemented by the electronic components of FIG. 2.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Vehicles (e.g. cars, trucks, vans, etc.) are equipped with rear view cameras. The vehicles are also equipped with range detection sensors (e.g., ultrasonic sensors, cameras, RADAR, LiDAR, etc.) that detect other objects (such as other vehicles) in the vicinity of the vehicle. Drivers are presented with situations where the driver wants to see behind the vehicle while the vehicle is moving forward. However, the rear-window may be temporarily blocked by, for example, snow, condensation, interior obstacles (e.g., large items in the cargo area), and/or passengers. As discussed in more detail below, images from the rear view camera are displayed to the driver when the vehicle is moving forward. An adaptive display controller displays the images (a) on demand, and/or (b) in situations that the adaptive display controller determines that the driver should view the images.

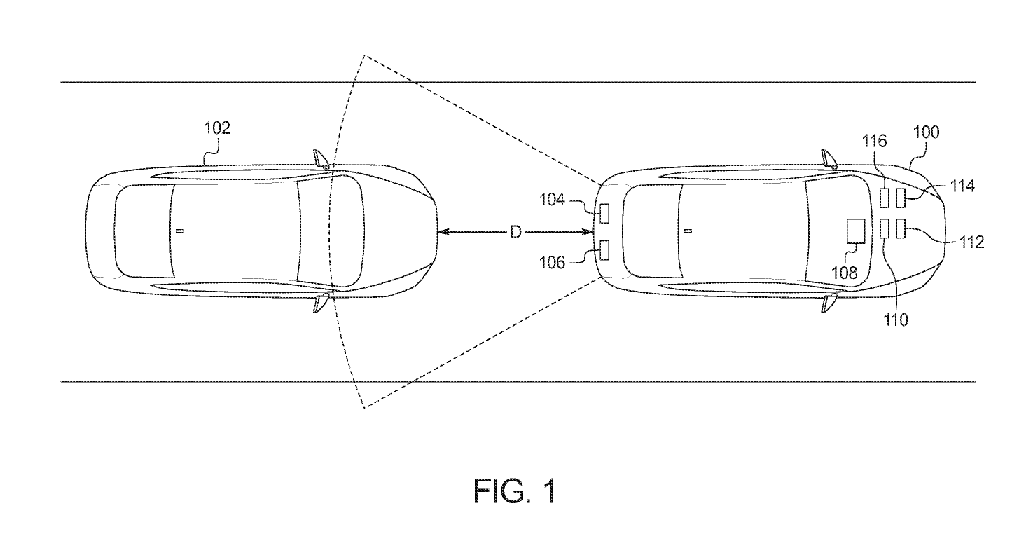

FIG. 1 is a top view of a vehicle 100 operating in accordance with the teachings of this disclosure. In the illustrated example, a nearby vehicle 102 is approaching or tailgating the vehicle 100 (sometimes referred to as “an adaptive view vehicle”). The nearby vehicle 102 is tailgating when the distance (D) between the nearby vehicle 102 and the adaptive view vehicle 100 is less than a stopping distance of the nearby vehicle 102. The vehicle 100 may be a standard gasoline powered vehicle, a hybrid vehicle, an electric vehicle, a fuel cell vehicle, or any other mobility implement type of vehicle. The vehicle 100 may be non-autonomous, semi-autonomous, or autonomous. The vehicle 100 includes parts related to mobility, such as a powertrain with an engine, a transmission, a suspension, a driveshaft, and/or wheels, etc. The adaptive view vehicle 100 includes a rear view camera 104, range detection sensors 106, an infotainment head unit 108, a steering control unit 110, a throttle control unit 112, a brake control unit 114, and an adaptive display controller 116.

The rear view camera 104 provides video images directed behind the adaptive view vehicle 100. The rear view camera 104 is positioned to view behind the adaptive view vehicle, and is installed, for example, proximate the rear license plate, a rear diffuser, or a third brake light. The range detection sensors 106 are positioned on the adaptive view vehicle 100 to detect objects within a range along a rear arc of the adaptive view vehicle 100. In some examples, the range detection sensors 106 are mounted to a rear bumper of the adaptive view vehicle 100. In some examples, the range detection sensors 106 are ultrasonic sensors that use high frequency sound waves to detect the nearby vehicles 102.

The infotainment head unit 108 provides an interface between the adaptive view vehicle 100 and a user (e.g., a driver, a passenger, etc.). The infotainment head unit 108 includes digital and/or analog interfaces (e.g., input devices and output devices) to receive input from the user(s) and display information. The input devices may include, for example, a control knob, an instrument panel, a digital camera for image capture and/or visual command recognition, a touch screen, an audio input device (e.g., cabin microphone), buttons, or a touchpad. The output devices may include instrument cluster outputs (e.g., dials, lighting devices), actuators, a dashboard panel, a heads-up display, a center console display (e.g., a liquid crystal display (“LCD”), an organic light emitting diode (“OLED”) display, a flat panel display, a solid state display, or a heads-up display), and/or speakers. The infotainment head unit 108 is communicatively coupled to the rear view camera 104. In some examples, the images from the rear view camera 104 are displayed on the center console display of the infotainment head unit 108. In some examples, the images from the rear view camera 104 are displayed on portion of a rear view mirror (not shown).

The steering control unit 110 is an electromechanical device that includes sensors to detect the position and torque of a steering column. The throttle control unit 112 electronically couples an accelerator pedal to a throttle of the adaptive view vehicle. The throttle control unit 112 includes sensors to detect a position of the accelerator pedal. The brake control unit 114 electrically couples a brake pedal to the braking system of the adaptive view vehicle 100. The brake control unit 114 may include an anti-lock brake control system and/or a traction control system. The brake control unit 114 includes sensors to detect a position of the brake pedal. In some examples, the brake control unit 114 is communicatively coupled to wheel speed sensors.

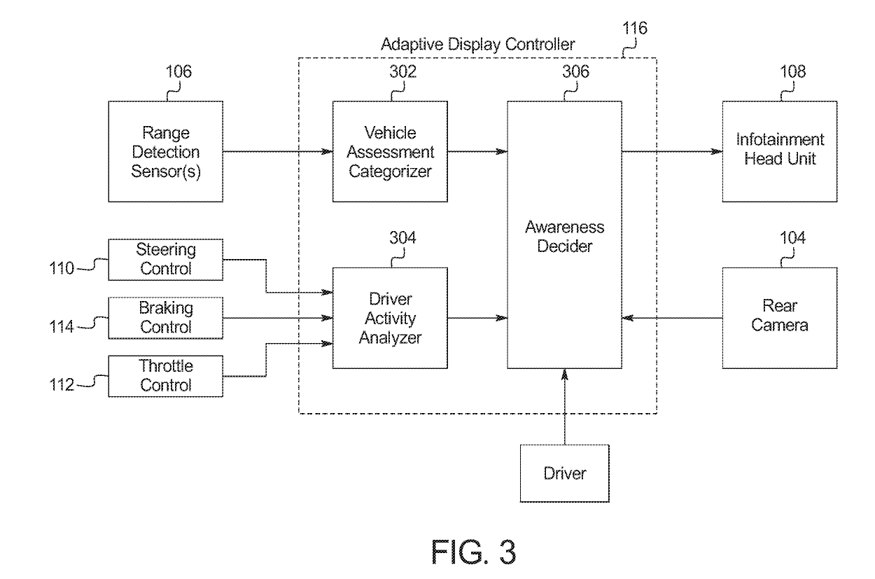

As discussed in connection with FIG. 3 below, the adaptive display controller 116 determines when to display the images captured by the rear view camera 104 while the adaptive view vehicle 100 is moving forward. To determine whether to display the images captured by the rear view camera 104, the adaptive display controller 116, using data collected by the range detection sensors 106, analyzes the (i) the speed and acceleration of the nearby vehicle 102 and (ii) the distance (D) between the nearby vehicle 102 and the adaptive view vehicle 100. Additionally, the adaptive display controller 116 analyzes the activity level of the driver to determine if the driver is currently engaged in a driving maneuver which may impact driver focus. The adaptive display controller 116 displays the images captured by the rear view camera 104 when (a) the adaptive display controller 116 detects that the nearby vehicle 102 is acting dangerously (e.g., is tailgating, is approaching the adaptive view vehicle quickly, etc.). In some examples, the adaptive display controller 116 provides an audible warning when the images captured by the rear view camera 104 are displayed. Additionally, in some examples, the driver may request the images captured by the rear view camera 104, via, for example, a button and/or touch screen on the infotainment head unit 108, a voice command, and/or a button on a steering wheel.

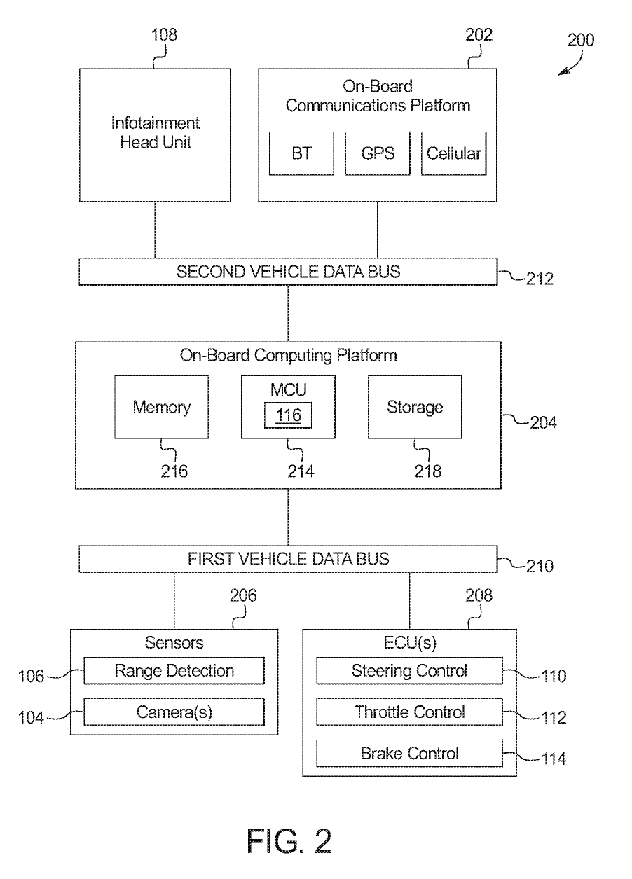

FIG. 2 is a block diagram of electronic components 200 of the adaptive view vehicle 100 of FIG. 1. The electronic components 200 include an example on-board communications platform 202, the example infotainment head unit 108, an on-board computing platform 204, example sensors 206, example electronic control units (ECUs) 208, a first vehicle data bus 210, and second vehicle data bus 212.

The on-board communications platform 202 includes wired or wireless network interfaces to enable communication with external networks. The on-board communications platform 202 also includes hardware (e.g., processors, memory, storage, antenna, etc.) and software to control the wired or wireless network interfaces. For example, the on-board communications platform 202 may include a cellular modem that incorporates controllers for standards-based networks (e.g., Global System for Mobile Communications (GSM), Universal Mobile Telecommunications System (UMTS), Long Term Evolution (LTE), Code Division Multiple Access (CDMA), WiMAX (IEEE 802.16m); and Wireless Gigabit (IEEE 802.11ad), etc.). The on-board communications platform 202 may also include one or more controllers for wireless local area networks such as a Wi-FI® controller (including IEEE 802.11 a/b/g/n/ac or others), a Bluetooth® controller (based on the Bluetooth® Core Specification maintained by the Bluetooth Special Interest Group), and/or a ZigBee® controller (IEEE 802.15.4), and/or a Near Field Communication (NFC) controller, etc. Further, the external network(s) may be a public network, such as the Internet; a private network, such as an intranet; or combinations thereof, and may utilize a variety of networking protocols now available or later developed including, but not limited to, TCP/IP-based networking protocols. The on-board communications platform 202 may also include a wired or wireless interface to enable direct communication with an electronic device (such as, a smart phone, a tablet computer, a laptop, etc.).

The on-board computing platform 204 includes a processor or controller 214, memory 216, and storage 218. In some examples, the on-board computing platform 204 is structured to include the adaptive display controller 116. Alternatively, in some examples, the adaptive display controller 116 may be incorporated into an ECU 208 with its own processor and memory. The processor or controller 214 may be any suitable processing device or set of processing devices such as, but not limited to: a microprocessor, a microcontroller-based platform, a suitable integrated circuit, one or more field programmable gate arrays (FPGAs), and/or one or more application-specific integrated circuits (ASICs). The memory 216 may be volatile memory (e.g., RAM, which can include non-volatile RAM, magnetic RAM, ferroelectric RAM, and any other suitable forms); non-volatile memory (e.g., disk memory, FLASH memory, EPROMs, EEPROMs, memristor-based non-volatile solid-state memory, etc.), unalterable memory (e.g., EPROMs), and read-only memory. In some examples, the memory 216 includes multiple kinds of memory, particularly volatile memory and non-volatile memory. The storage 218 may include any high-capacity storage device, such as a hard drive, and/or a solid state drive.

The memory 216 and the storage 218 are a computer readable medium on which one or more sets of instructions, such as the software for operating the methods of the present disclosure can be embedded. The instructions may embody one or more of the methods or logic as described herein. In a particular embodiment, the instructions may reside completely, or at least partially, within any one or more of the memory 216, the computer readable medium, and/or within the processor 214 during execution of the instructions.

The terms “non-transitory computer-readable medium” and “computer-readable medium” should be understood to include a single medium or multiple media, such as a centralized or distributed database, and/or associated caches and servers that store one or more sets of instructions. The terms “non-transitory computer-readable medium” and “computer-readable medium” also include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

The sensors 206 may be arranged in and around the adaptive view vehicle 100 in any suitable fashion. In the illustrated example, the sensors 206 include the rear view camera 104 and the range detection sensors 106. The range detection sensors 106 may be any suitable sensor that detects objects (e.g., the nearby vehicle 102) near the vehicle, such as ultrasonic sensors, RADAR sensors, LiDAR sensors, and/or cameras, etc.

The ECUs 208 monitor and control the systems of the adaptive view vehicle 100. The ECUs 208 communicate and exchange information via the first vehicle data bus 210. Additionally, the ECUs 208 may communicate properties (such as, status of the ECU 208, sensor readings, control state, error and diagnostic codes, etc.) to and/or receive requests from other ECUs 208. Some vehicles 100 may have seventy or more ECUs 208 located in various locations around the vehicle 100 communicatively coupled by the first vehicle data bus 210. The ECUs 208 are discrete sets of electronics that include their own circuit(s) (such as integrated circuits, microprocessors, memory, storage, etc.) and firmware, sensors, actuators, and/or mounting hardware. In the illustrated example, the ECUs 208 include the steering control unit 110, the throttle control unit 112, and the brake control unit 114.

The first vehicle data bus 210 communicatively couples the sensors 206, the ECUs 208, the on-board computing platform 204, and other devices connected to the first vehicle data bus 210. In some examples, the first vehicle data bus 210 is implemented in accordance with the controller area network (CAN) bus protocol as defined by International Standards Organization (ISO) 11898-1. Alternatively, in some examples, the first vehicle data bus 210 may be a Media Oriented Systems Transport (MOST) bus, or a CAN flexible data (CAN-FD) bus (ISO 11898-7). The second vehicle data bus 212 communicatively couples the on-board communications platform 202, the infotainment head unit 108, and the on-board computing platform 204. The second vehicle data bus 212 may be a MOST bus, a CAN-FD bus, or an Ethernet bus. In some examples, the on-board computing platform 204 communicatively isolates the first vehicle data bus 210 and the second vehicle data bus 212 (e.g., via firewalls, message brokers, etc.). Alternatively, in some examples, the first vehicle data bus 210 and the second vehicle data bus 212 are the same data bus.

FIG. 3 is a block diagram of the adaptive display controller 116 of FIGS. 1 and 2. The adaptive display controller 116 determines when to display images captured by the rear view camera 104 by the infotainment head unit 108 while the adaptive view vehicle 100 is moving forward. In the illustrated example, the adaptive display controller 116 includes a vehicle assessment categorizer 302, a driver activity analyzer 304, and an awareness decider 306.

The vehicle assessment categorizer 302 provides situational awareness of nearby vehicles 102 behind the adaptive view vehicle 100. The vehicle assessment categorizer 302 is communicatively coupled to the range detection sensors 106. Using the range detection sensors 106, the vehicle assessment categorizer 302 determines (e.g., calculates) a velocity and a distance (D) of the nearby vehicles 102 behind the adaptive view vehicle 100. The vehicle assessment categorizer 302 computes a following time (FT) for the nearby vehicles 102 behind the adaptive view vehicle 100. The vehicle assessment categorizer 302 computes the following time (FT) in accordance with Equation (1) below.

$$FT ( k ) = \frac{distance ( k )}{max ( velocity ( k ) , α )} \qquad Equation ( 1 )$$

In Equation (1) above, k is an instance in time, distance(k) is the distance between the nearby vehicle 102 behind the vehicle 100 and the vehicle 100 at time k, velocity(k) is the velocity of the nearby vehicle 102 at time k, and α is the minimum allowable velocity. In some examples, α is 1.5 meters per second. For example, if the distance between the adaptive view vehicle 100 and the nearby vehicle 102 is 7 meters (23 feet) and the speed of the nearby vehicle is 15.6 meters per second (35 miles per hour), the following time (FT) may be 0.45 seconds. In some examples, when the following time (FT) is less than 1.0 second, the nearby vehicle 102 is classified as tailgating. From time to time (e.g., periodically, aperiodically, etc.), the vehicle assessment categorizer 302 determines the following time (FT). For example, the vehicle assessment categorizer 302 may determine the following time (FT) every half a second. As another example, the vehicle assessment categorizer 302 may determine the following time (FT) every second in response to detecting the nearby vehicle 102 behind the adaptive view vehicle 100.

The driver activity analyzer 304 provides a workload estimate for the driver of the adaptive view vehicle 100. The driver activity analyzer 304 provides a value range (e.g., from 0 to 1) characterizing visual, physical and cognitive demands of the driver while driving the vehicle. A high workload estimate means that the driver is engaged in the act of driving (e.g., changing lanes, turning, navigating curves of a road, etc.) and may not have the visual, physical and/or cognitive ability to process another item of information (e.g., images captured from the rear view camera 104 displayed on the infotainment head unit 108, etc.). In the illustrated example, the driver activity analyzer 304 is communicatively coupled to the steering control unit 110, the throttle control unit 112, and the brake control unit 114. In some examples, the driver activity analyzer 304 bases the workload estimate on (a) a mean velocity of the adaptive view vehicle 100, (b) a maximum velocity of the adaptive view vehicle 100, (c) a mean gap time between the adaptive view vehicle 100 and a vehicle ahead of the adaptive view vehicle 100, (d) a minimum gap time between the adaptive view vehicle 100 and the vehicle ahead of the adaptive view vehicle 100, (e) a brake reaction time (e.g., amount of time between a recognition of a hazard on the road and the application of the brakes), (f) brake jerks, (g) steering wheel reversal rate, (h) interaction with the infotainment head unit and/or steering wheel controls, (i) traffic density, and/or (j) driving location, etc. Examples of determining the workload estimate are described in U.S. Pat. No. 8,924,079, entitled “Systems and methods for scheduling driver interface tasks based on driver workload,” which is hereby incorporated by reference in its entirety.

The awareness decider 306 receives the following-time (FT) from the vehicle assessment categorizer 302 and the workload estimate from the driver activity analyzer 304. Based on the following-time (FT), the workload estimate, and, in some examples, input from the driver, the awareness decider 306 determines whether to display the images captured by the rear view camera 104 on the infotainment head unit 108. In some examples, the driver requests to view (e.g., via the steering wheel, via the infotainment head unit 108, etc.) the images being captured by the rear view camera 104 on demand without the awareness decider 306 analyzing the follow time (FT) and the workload estimate. Additionally, in some examples, the driver enable or disable (e.g., via the steering wheel, via the infotainment head unit 108, etc.) the awareness decider 306. In such examples, if the awareness decider 306 is disabled, the awareness decider 306 does not display the images captured by the rear view camera 104 on the infotainment head unit 108. If the awareness decider 306 is enabled, the awareness decider 306 compares the following-time (FT) to a following closeness threshold (λ) and the workload estimate to a driver activity threshold (δ). The awareness decider 306 displays the images being captured by the rear view camera 104 on the infotainment head unit 108 when (i) the following-time (FT) satisfies (e.g., is less than or equal to) the following closeness threshold (λ), and (ii) the workload estimate satisfies (e.g., is less than or equal to) the driver activity threshold (δ). In some examples, the following closeness threshold (λ) is 1.0 second. In some examples, the driver activity threshold (δ) is 0.4.

In response to the following-time (FT) satisfying the following closeness threshold (λ) and the workload estimate satisfying the driver activity threshold (δ), the awareness decider 306 displays the images that are being captured by the rear view camera 104 on the infotainment head unit 108. In some examples, the awareness decider 306 displays the images for a configurable duration (e.g., one second, two seconds, three seconds, etc.). Alternatively, in some examples, the awareness decider 306 displays the images while the follow time (FT) satisfies the following closeness threshold (λ) and the workload estimate satisfies the driver activity threshold (δ). In some examples, when the driver is requesting the images on demand, the awareness decider 306 displays the images for a duration equal to an equivalent average time to glance at the rear-view mirror (e.g., one second, two seconds, etc. which may be determined, for example, by a camera in the cabin of the adaptive view vehicle 100 or may be based on a statistical average).

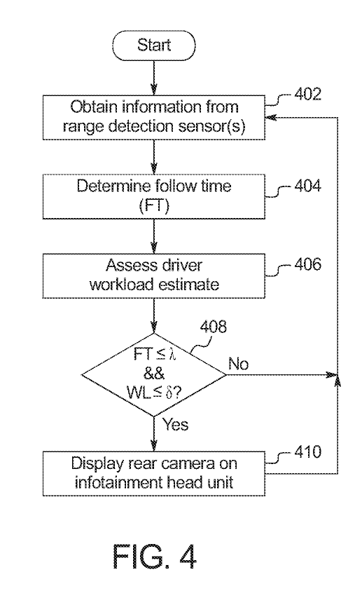

FIG. 4 is a flowchart of an example method to provide an adaptive rear view display that may be implemented by the electronic components 200 of FIG. 2. Initially, at bock 402, the vehicle assessment categorizer 302 obtains information from the range detection sensors 106. At block 404, the vehicle assessment categorizer 302 determines the following-time (FT) based on the information received at block 402. At block 406, the driver activity analyzer 304 accesses the workload estimate for the driver of the adaptive view vehicle 100. At block 408, whether the follow time (FT) satisfies the following closeness threshold (λ) and the workload estimate satisfies the driver activity threshold (δ). In some examples, the awareness decider 306 also determines whether the driver has enabled the adaptive display controller 116 and/or whether the driver has requested the output of the rear view camera 104 on demand. If the follow time (FT) satisfies the following closeness threshold (λ) and the workload estimate satisfies the driver activity threshold (δ), at block 410, the awareness decider 306 displays the output of the rear view camera 104 on the infotainment head unit 108.

The flowchart of FIG. 4 is a method that may be implemented by machine readable instructions that comprise one or more programs that, when executed by a processor (such as the processor 214 of FIG. 2), cause the adaptive view vehicle 100 to implement the adaptive display controller 116 of FIGS. 1, 2, and 3. Further, although the example program(s) is/are described with reference to the flowchart illustrated in FIG. 4, many other methods of implementing the example adaptive display controller 116 may alternatively be used. For example, the order of execution of the blocks may be changed, and/or some of the blocks described may be changed, eliminated, or combined.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A first vehicle comprising:
a rear view camera; and
an adaptive display controller to:
determine, with range detection sensors, a following-time of a second vehicle behind the first vehicle;
determine a workload estimate associated with a user of the first vehicle; and
when the first vehicle is moving forward, selectively display video from the rear view camera based on the following-time and the workload estimate.

2. The first vehicle of claim 1, wherein to determine the following-time of the second vehicle, the adaptive display controller is to calculate a velocity of the second vehicle and a distance between the first vehicle and the second vehicle.

3. The first vehicle of claim 1, wherein to selectively display the video from the rear view camera, the adaptive display controller is to compare the following-time to a first threshold and the workload estimate to a second threshold.

4. The first vehicle of claim 3, wherein the adaptive display controller is to display video from the rear view camera when the following-time is less than the first threshold and the workload estimate is less than the second threshold.

5. The first vehicle of claim 3, wherein the adaptive display controller is to display video from the rear view camera when the follow time is less than the first threshold, the workload estimate is less than the second threshold, and an input indicates that the driver enabled the video from the rear view camera to be displayed.

6. The first vehicle of claim 1, wherein the adaptive display controller is to display video from the rear view camera on at least one of an infotainment head unit or a rear view mirror when a request is made by the driver.

7. The first vehicle of claim 6, wherein the adaptive display controller is to display video from the rear view camera for a period of time between one and three seconds.

8. A method to provide a driver a view behind a first vehicle comprising:
determining, with a processor, a following-time of a second vehicle behind the first vehicle, the second vehicle detected by range detection sensors;
determining a workload estimate associated with a user of the first vehicle; and
when the first vehicle is moving forward, selectively displaying video from a rear view camera based on the following-time and the workload estimate.

9. The method of claim 8, wherein determining the following-time of the second vehicle includes calculating a velocity of the second vehicle and a distance between the first vehicle and the second vehicle.

10. The method of claim 8, wherein selectively displaying the video from the rear view camera includes comparing the following-time to a first threshold and the workload estimate to a second threshold.

11. The method of claim 10, including displaying the video from the rear view camera when the following-time is less than the first threshold and the workload estimate is less than the second threshold.

12. The method of claim 10, including displaying video from the rear view camera when the following-time is less than the first threshold, the workload estimate is less than the second threshold, and an input indicates that the driver enabled video from the rear view camera to be displayed.

13. The method of claim 8, wherein the video from the rear view camera is displayed on at least one of an infotainment head unit or a rear view mirror when a request is made by the driver.

14. The method of claim 13, wherein the video from the rear view camera is displayed for a period of time between one and three seconds.

15. A tangible computer readable medium comprising instructions that, when executed, causes a first vehicle to:
determine a following-time of a second vehicle behind the first vehicle, the second vehicle detected by range detection sensors;
determine a workload estimate associated with a user of the first vehicle; and
when the first vehicle is moving forward, selectively display video from a rear view camera based on the following-time and the workload estimate.
